(19) United States
(12) Patent Application Publication
(10) Pub. No.: US 2005/0189268 A1
(43) Pub. Date: Sep. 1, 2005

(54) Method and device for presorting loose and scanned flat postal articles provided with distributing information

(76) Inventor: Armin Zimmermann, Konstanz (DE)

Correspondence Address: SIEMENS SCHWEIZ;I-44, INTELLECTUAL PROPERTY, ALBISRIEDERSTRASSE 245, ZURICH, CH-8047, CH

(21) Appl. No.: 10/942,884

(22) Filed: Sep. 17, 2004

Related U.S. Application Data
(63) Continuation of application No. PCT/DE03/00838, filed on Mar. 14, 2003.

(30) Foreign Application Priority Data
Mar. 19, 2002 (DE) 102 12 086.2

(51) Int. Cl. B07C 5/00; G06K 9/00

(52) U.S. Cl. 209/583

(57) ABSTRACT

The present invention relates to presorting at a number of sorting terminal stations of a postal sorting system. A multitude of adjacent, narrow and laterally open storage cells are provided, which accommodate one postal article at a time in an upright position and which are fastened to an endless traction mechanism that circulates at a constant speed. These storage cells can, in a loading and unloading section of the circulation, be loaded via an open narrow side by means of one or more adjacent conveying devices and can be unloaded via the other open narrow side by means of a number of adjacent conveying devices. In order to carry out the sorting inward or outward transfer into or from the storage cells, the loading and/or unloading conveying devices can be displaced and controlled independent of one another over an area spanning a number of storage cell widths.

Method and device for pre-sorting loose and scanned flat items of mail having distributing information

The invention relates to a method and a device for pre-sorting loose and scanned flat items of mail, having distributing information, to a plurality of areas of sorting terminal stations, which can be reached via distributing points, of an item of mail sorting system.

In known sorting devices, a stream of individual items of mail is produced in what is referred to as a material input station, said individual items of mail being read, processed and sorted in subsequent assemblies. Each destination address is assigned a terminal station. The items of mail are conveyed in the longitudinal direction in the sorting device. In order to make available sufficient time for the addresses to be read as distributing information after the corresponding surfaces of the items of mail have been scanned, apparatuses for buffering the items of mail are located downstream of the scanner, in which buffering apparatuses the items of mail remain for a specific time until they are conveyed to the terminal stations via distributing points.

Various solutions for implementing a buffer have been disclosed. For example, the buffering is carried out by the loose items of mail, which have been placed for example at a constant distance from one another, being conveyed as a stream of items of mail in their existing order in a storage section which is composed essentially of a ceiling belt system. The required storage time is obtained as a result of the corresponding length of the storage section together with a given conveying speed (EP 0 734 349 B1).

In another buffer, the items of mail are loaded laterally into storage cells which are moved incrementally past an input station in a continuous conveyor loop, and are unloaded out of the storage cell after at least one circulation (DE 196 24 968 C1). A sorting device for flat items has also been disclosed in which adjacent containers for conveyed items are moved by means of a conveyor device and the items are transferred inward laterally in a horizontal fashion into the containers for conveyed items and are transferred outward in a vertically controlled sorting fashion into containers which are located below. A feeder device has a horizontally swivelable conveyor duct which is swivelled together with the container for conveyed items during the inward transfer process in order to ensure a minimum inward transfer time, and is then swivelled back again quickly. (EP 0 851 793 B1),

Further sorting devices with circulating storage cells have been disclosed (DE 1 574 155 A, DE 199 43 361 C1), in which the items of mail to be sorted are conducted in adjacent compartments. The described sorting devices do not have the object of pre-sorting at least one stream of items of mail among a plurality of streams of items of mail, and are not suitable for this purpose either.

Although the conveying devices which are loaded by storage cells can be swivelled over a plurality of storage cell widths, this is also carried out only in order to prolong the loading time available so that the feeding speed can be kept relatively low during loading.

A selective change in the sequence of the items in the containers for conveyed items or memory cells in comparison with the sequence in the stream of items which is fed in is not provided. If items of mail for a plurality of sorting areas of a sorting machine are to be distributed in parallel, according to the prior art the items of mail have to be pre-sorted in a preliminary process on a pre-sorting machine and then fed to the sorting machine by means of material input stations which are assigned to each sorting area. This is time consuming owing to the separate pre-sorting process and requires additional expenditure on hardware. Each preliminary sorting process requires a storage section in order to provide time which is necessary for reading the distributing information.

The invention is therefore based on the object of providing a method and a device for pre-sorting to a plurality of sorting areas of a sorting machine which are to be fed in parallel and which eliminate the necessity for preliminary pre-sorting to sorting machines.

The object of the invention is achieved by means of the features of claims 1 and 4.

In order to carry out pre-sorting, a plurality of adjacent, narrow and laterally open storage cells which accommodate one item of mail at a time in an upright position and are fastened to a continuous circulating traction means are provided. The narrow sides of the storage cells are aligned perpendicularly with respect to their direction of movement. In a loading and unloading section of the circulation, the storage cells are loaded via the one open narrow side by means of one or more adjacent conveying devices and are unloaded from the other open narrow side by means of a plurality of adjacent conveying devices. So that inward transfer into specific storage cells which are moved past or outward transfer out of specific storage cells which are moved past can be carried out as a function of known distributing information which is assigned to the items of mail and as a function of the active sorting scheme, the loading and/or unloading conveying devices are moved and actuated independently over an area spanning a plurality of storage cell widths. With this solution it is possible to implement the functionalities of buffering and pre-sorting in one assembly at very low cost.

Advantageous embodiments of the invention are presented in the subclaims.

It is thus particularly advantageous to distribute the items of mail to the areas in as far as possible. uniform streams of items of mail in terms of the number of items of mail per time unit. As a result it is possible to increase the throughput rate of a sorting machine without increasing the conveying speed in the distributing area. Since the average gap in a sorting machine with statistical distribution of the distributing information (for example destination addresses) becomes greater in the direction of the end of the machine, because more and more items of mail have already been eliminated, the length which influences the increase in the gaps is reduced by dividing the distribution into areas and by parallel feeding. This dividing of the distribution distributes the items of mail ideally in a continuous stream to the conveying devices which are assigned to theareas. This means that the items of nail are ideally continuously alternately distributed to two outlets when there is only one pre-sorting inlet. However, since, owing to the statistically distributed distributing information on the items of mail and the limited swivelling range of the feeding and/or discharging conveying devices, this ideal distribution cannot be continuously maintained, the item of mail which is to be pre-sorted at a particular time is loaded into the respective storage cell as a function of the number of subsequent items of mail whose distributing information is already known, i.e. as a function of how extensive the preview of the items of mail to be pre-sorted is, and as a function of the swivelling range, in a way which is known to a person skilled in the art, and said item of mail is then unloaded from said storage cell into the area provided, with the result that the distribution division which is provided takes place as uniformly as possible.

In order to make available sufficient time for the process of reading even distributing information which cannot be unambiguously read by the OCR reader, it is advantageous to transfer all the items of mail out of their storage cells only after one complete circulation. The time for this circulation is then available for video coding. In the process, the unloaded conveying devices are arranged laterally offset with respect to the loaded conveying devices in the direction opposite to the circulation direction so that the storage cells are, apart from a few exceptions, empty again at the loading station. The number of storage cells which can be used, and thus the length of the traction means as well as the conveying speed of the traction means are therefore products of the required parameters of the storage time and throughput rate.

If items of mail cannot be successfully read in the storage cell during the dwell time provided, they may advantageously remain in the respective circulating storage cell up to a defined maximum time. As a result, additional time for determining the distributing information is made available.

It is advantageous to supply each feeding conveying device from a dedicated separating device by means of a separate scanner.

So that the floor area which is required for the pre-sorting device is as small as possible, in one advantageous configuration the continuous traction means with the storage cells extends in the form of a double helix.

It is also advantageous to make the swivelable conveying devices capable of being actuated in such a way that during the inward and outward transfers of the items of mail they can be swivelled with essentially the same direction and speed as the moved storage cells, As a result, the time available for the inward and outward transfer is made as long as possible.

If the lengths of the items of mail differ greatly, the items of mail are advantageously distributed among the streams of items of mail in such a way that the average length of an item of mail in each stream of items of mail is approximately the same per defined time unit. As a result, throughput losses are avoided.

The invention is subsequently explained in more detail in an exemplary embodiment with reference to the drawings, in which:

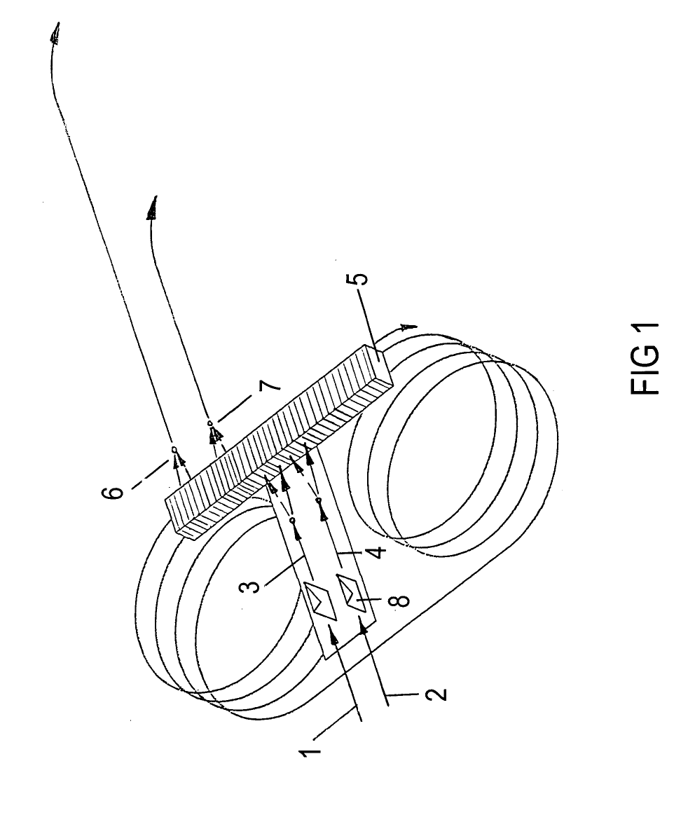

FIG. 1 is a schematic view of a device for pre-sorting with two inlets and outlets and storage cells which extend in the form of a double helix;

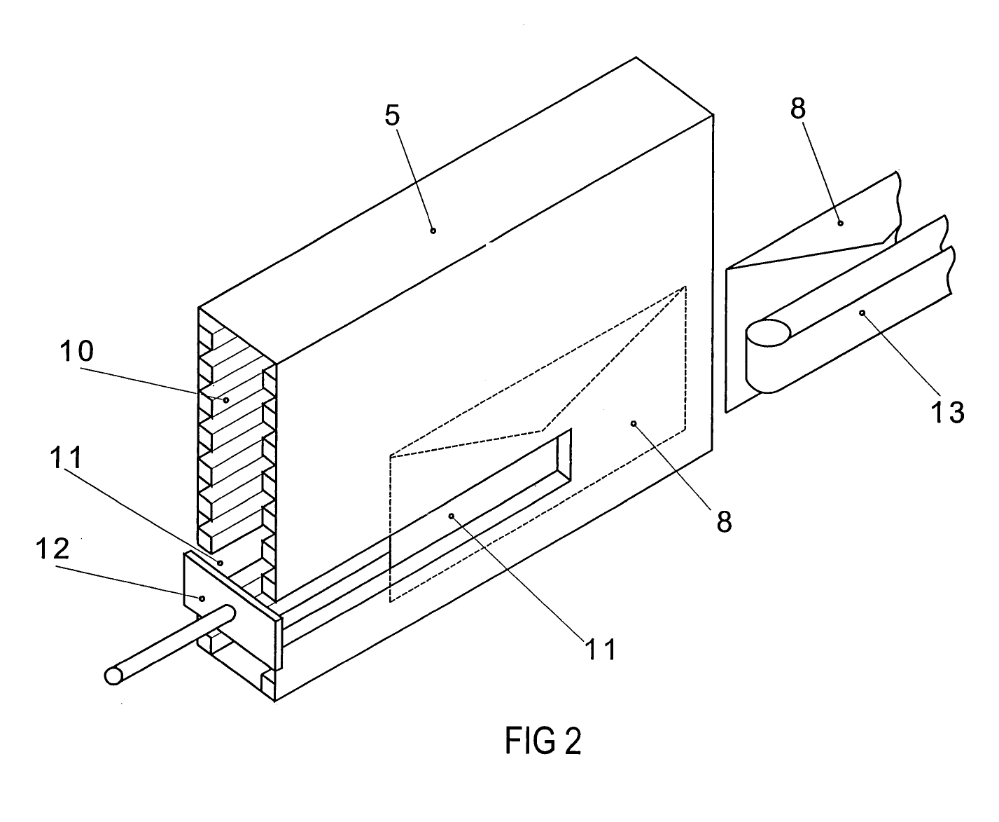

FIG. 2 is a schematic representation of a storage cell with a conveying device for unloading;

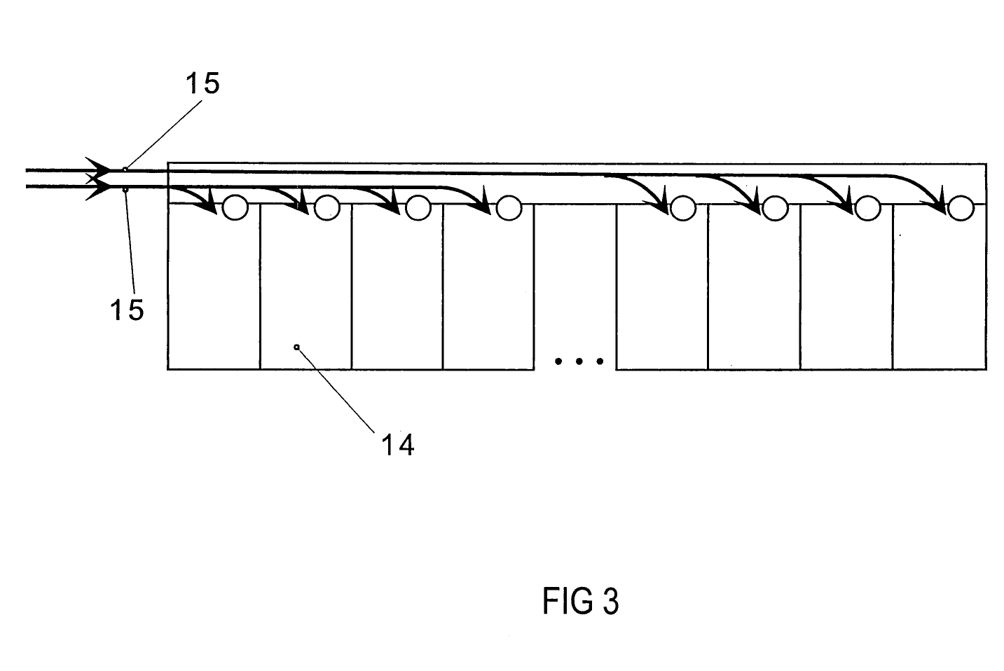

FIG. 3 is a schematic side view of a distribution section with two distribution areas and separate conveying sections which lead to them;

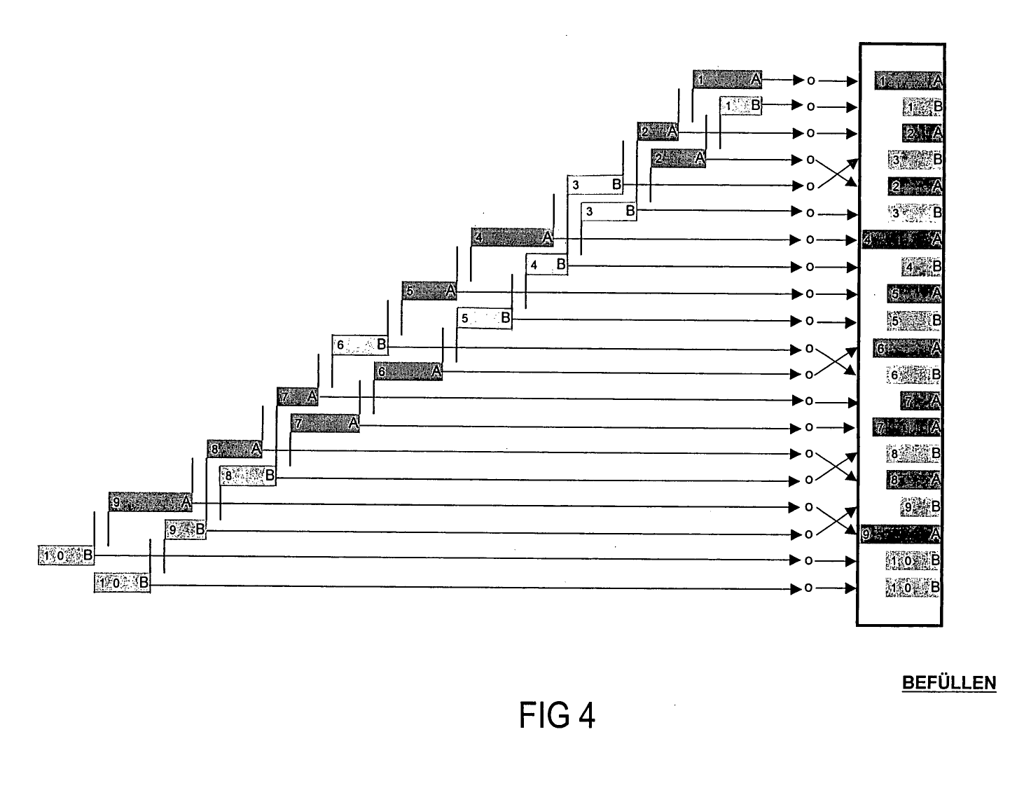

FIG. 4 is a schematic representation of the swivelling processes of two loading conveying devices which can swivel over two storage cells, as a function of the distribution of the items of mail;

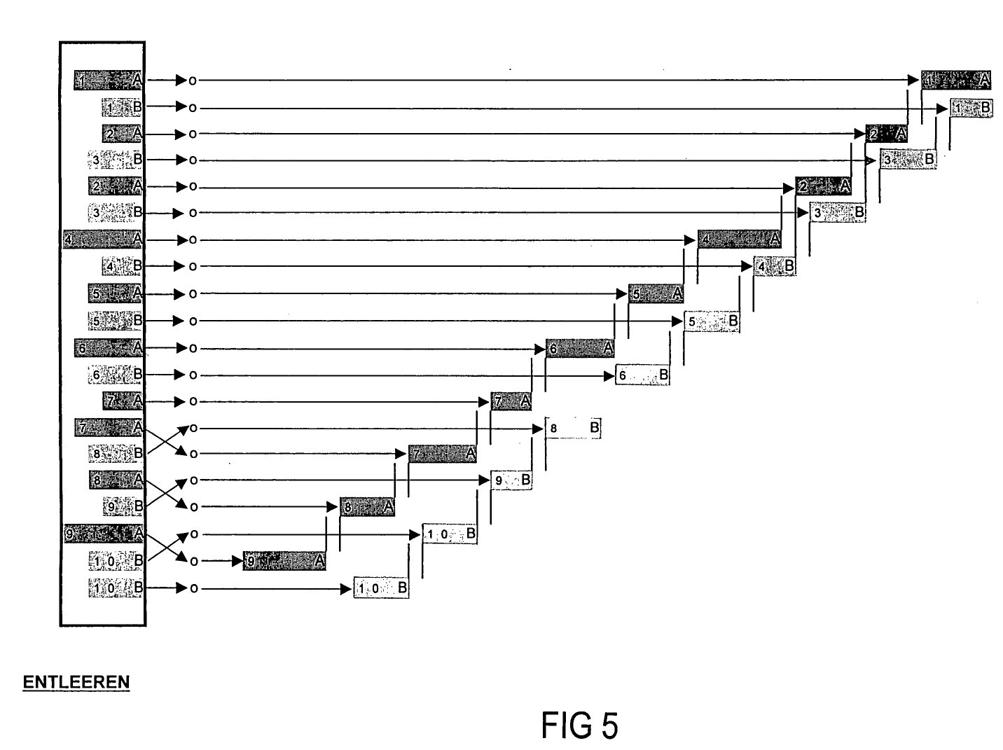

FIG. 5 is a schematic representation of the swivelling processes of two unloading conveying devices, which can swivel over two storage cells, as a function of the distribution of the items of mail in the storage cells; and

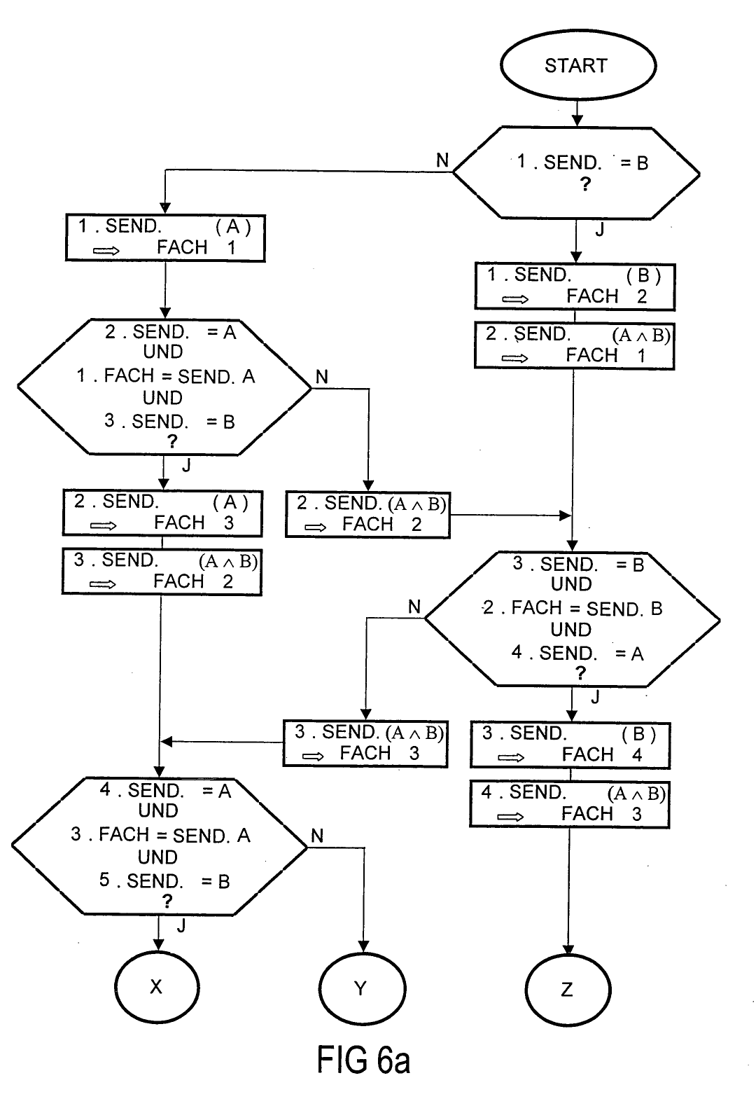

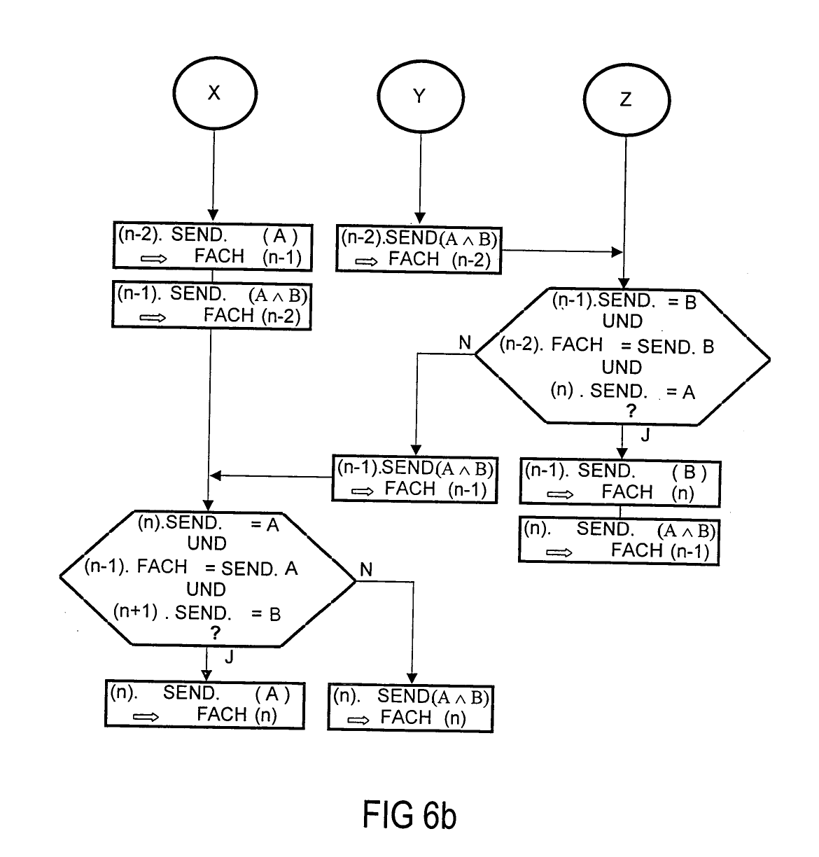

FIGS. 6a, b are a flowchart explaining the decision process for loading the storage cells.

A device for pre-sorting is illustrated in principle in FIG. 1. Here, two streams of scanned items of mail 8, whose distributing information has then been automatically determined in reading devices, are each fed to a conveying path 1, 2 of a loading conveying device 3, 4 of a loading and unloading section. As indicated with the dashed arrow, the downstream parts of the conveying devices 3, 4 can be swivelled in the horizontal direction.

Adjacent, narrow storage cells 5 which accommodate one item of mail 8 at a time in an upright position on one narrow side and which are fastened to a continuous traction means which circulates at a constant speed move past the conveying devices 3, 4. The laterally open storage cells 5 are aligned with their narrow sides perpendicularly with respect to the direction of movement of the storage cells and move linearly and horizontally aligned in the loading and unloading section past the conveying devices 3, 4. In this area, there are also unloading conveying devices 6, 7 whose parts which face the storage cells 5 and accommodate the items of mail 8 can also be swivelled horizontally.

As a result of these selective swivelling movements, by means of permutations, the items of mail 8 of the two streams of items of mail are distributed between two discharging conveying lines, each assigned to one distributing area, in accordance with the distributing information on the items of mail 8 which is assigned to the distributing areas, in such a way that the discharging streams are as far as possible identical in terms of the number of items of mail 8 per time unit. Limits on this are predefined by the degree of equal distribution in terms of the distributing information on the feeding conveying lines 1, 2 and the swivelling ranges of the conveying devices 3, 4, 6, 7. So that, when the items of mail 8 are transferred into the storage cells 5, they do not drop out again at the other open side, a spatially fixed impact wall (not illustrated) is located at the rear open narrow sides on the loading station. The unloading station is located as far as possible right next to the loading station so that the proportion of unused storage cells 5 is minimized. Each item of mail 8 remains in its storage cell 5 during one circulation, so that sufficient video coding time is also available for the items of mail 8 which have not automatically been read in an unambiguous fashion. So that the read items of mail have left the storage cells 5 again at the loading station, and there is thus space again for new items of mail, the unloading station is displaced laterally with respect to the loading station in the direction opposite to the circulating direction. If, in rare cases, the distributing information has not been recognized during the circulation of the items of mail, additional time can be made available for the reading task by the respective item of mail 8 remaining for one or more further circulations in the memory cell 5, and only being transferred out subsequently. Furthermore, the items of mail must also stay longer in the storage cells 5 if immediate outward transfer in the corresponding line with a highly unequal distribution of the incoming items of mail is not possible.

The items of mail 8 which have not yet been read during the loading process can of course only be sorted by swivelling the unloading conveying devices 6, 7 so that in the most unfavorable case the respective item of mail 8 has to remain in the storage cell 5 for a further circulation until unloading into the distributing area provided is possible.

If the unloading conveying devices 6, 7 were to be arranged laterally offset with respect to the loading station in the circulation device, the read items of mail 8 could be transferred outward again but the items of mail 8 for which video coding were still to be performed would still be located in the storage cells 5 at the loading station after one circulation so that loading without a loss of performance is not possible. So that sufficient time is available for the items of mail 8 to be transferred into and out of the storage cells at a relatively high circulating speed, the loading and unloading conveying devices 3, 4, 6, 7 additionally follow the storage cells 5 at the circulating speed during the inward and outward transfers and then swivel quickly back again.

The part for removing the items of mail 8 from the storage cells 5 of the unloading conveying device is illustrated schematically in FIG. 2.

In order to reduce the friction at the longitudinal sides of the items of mail 8, the leading sides have narrow webs 10 which reduce the leading surface.

Furthermore, each storage cell 5 has a horizontally aligned recess 11 through which a plunger 12, as a component of the unloading conveying device 6, 7, pushes the item of mail 8 out of the storage cell 5 and into a ceiling belt system 13 which takes it over and which transports away the items of mail 8 which are clamped into it. With respect to this problem, reference is made also to the explanatory prior art (U.S. Pat. No. 5,324,025; DE 196 24 968 C1) in which further solution possibilities are disclosed.

FIG. 3 is a schematic representation of a series of sorting compartments 14 of a sorting machine, which compartments are divided into two areas and which each receive the items of mail via a separate conveying path,

FIGS. 4 and 5 show how the respective first 10 items of mail of the two streams of items of mail according to FIG. 1 are sorted in accordance with their association with the two areas A, B during the loading and unloading processes, in such a way that only items of mail for the area A are output without interruption at an outlet of the pre-sorter, and only items of mail for the area B are output without interruption at the other outlet. In this context, the swivelling range of the conveying devices spans two storage cells widths. As is apparent from FIG. 4, the first 10 items of mail of the stream of items of mail which is present at the left-hand inlet have the assignment A, A, B, A, A, B, A, A, A, B and the first 10 items of mail of the stream of items of mail which is present at the right-hand inlet have the assignment B, A, B, B, B, B, A, A, B, B, B.

The distribution division among the storage cells depends quite generally on how far it is possible to look into the future with respect to the assignment of the following items of mail to the areas. In this example, the preview of the next item of mail has been selected in accordance with the swivelling range (2 storage widths). This makes it easy to represent the principle which can then be applied analogously with a relatively large swivelling range and a further view of the incoming items of mail. In FIG. 4, the top two inlets represent the first timing cycle with the occupation A, B. It is not necessary to change the sequence for the storage and outputting. The two inlets which lie below that represent the subsequent second timing cycle. An item of mail for the area A is present at both inlets. Since it is known that two items of mail for the area B will then pass to the inlets (see third timing cycle), the desired assignment can already be brought about in the memory cells by interchanging the sequence of the item of mail for the area A at the rear inlet in the circulating direction in the timing cycle 2 with the item of mail, present at the front inlet in the circulating direction in the third timing cycle, for the area B, so that, as is also shown, the two items of mail can be transferred outward directly in this sequence.

The items of mail which are present at the two inlets of the pre-sorting device in the timing cycles 4 and 5 already have the desired distribution so that it is not necessary to interchange the sequence. In the sixth timing cycle, two items of mail for the areas A and B are present, but swapped over, at the two inlets, i.e. the sequence during the transfer into storage is changed. In the timing cycle 7, items of mail for the area A are present at the two inlets. Since it is also known that in timing cycle 8 an item of mail for the area A is also present at the front inlet in the circulating direction, and an item mail for the area B is present at the other inlet, the items of mail of the timing cycle 7 are transferred into storage without being swapped over, but the items of mail of the timing cycle 8 are stored after having been swapped over since otherwise the desired sequence can no longer be produced during the outward transfer process, an the timing cycle 9, an item of mail for the area A is present at the front inlet in the circulating direction, and an item of mail for the area B is present at the other inlet, i.e. actually in the correct order/sequence. However, since it is known that two items of mail for the area B will subsequently be present, and in the timing cycle 8 the incorrect sequence was stored in the storage cells, it is also necessary to change the sequence of the items of mail of the timing cycle 8.

In FIG. 5, the transfer of the items of mail out of the storage elements by means of the unloading conveying devices is illustrated, As is apparent, the first 13 storage cells are emptied without a change in sequence. The next following three pairs of storage cells are each emptied in a changed sequenced so that the items of mail with the agreed area assignment are output at the two outlets of the pre-sorting device. The last storage element is emptied without a change in sequence.

In FIGS. 6a and 6b, the decision process with respect to the inward transfer of the items of mail into the storage cells is explained in a flowchart, the first item of mail being present at the front inlet in the circulation direction, and the second item of mail being present at the rear inlet in the circulating direction, in the timing cycle 1, etc. It is also to be emphasized once more that the sorting process according to the object forms part of the capabilities of an average person skilled in the appropriate art.

1. A method for pre-sorting loose and scanned flat items of mail, having distributing information, to a plurality of areas of sorting terminal stations of an item of mail sorting system, in which a plurality of adjacent, narrow and laterally open storage cells which accommodate one item of mail at a time in an upright position on one narrow side, are fastened to a continuous traction means which circulates at constant speed, and whose narrow sides are aligned perpendicularly with respect to the direction of movement of the storage cells, in a loading and unloading section of the circulation, are loaded via the one open narrow side by means of one or more adjacent conveying devices and are unloaded from the other open narrow side by means of a plurality of adjacent conveying devices, comprising the steps of:
sorting at least one of inward and outward transfer into specific storage cells as a function of distributing information assigned to items of mail to be transferred; and
as a function of the active sorting scheme, moving and independently actuating at least one of loading and unloading conveying devices over an area spanning a plurality of storage cell widths.

2. The method according to claim 1, wherein the items of mail are distributed to areas in as far as possible uniform streams of items of mail in terms of a number of items of mail per time unit.

3. The method according to claim 1, wherein each item of mail is transferred out of the storage cell after one circulation at the earliest, and wherein the unloading conveying devices are arranged laterally offset with respect to the loading conveying devices in an opposite direction to a circulation direction.

4. The method according to claim 1, wherein items of mail which are located in a storage cell and are not unambiguously recognized before they leave the unloading section, remain in a respective circulating storage cell until a defined maximum time if immediate outward transfer is not possible or in order to obtain additional time for determination of distributing information.

5. The method according to claim 1, wherein each feeding conveying device is fed from a dedicated separating device by means of a separate scanner.

6. The method according to claim 1, wherein swivelable feeding and discharging conveying devices are actuated in such a way that during inward and outward transfers of items of mail, the devices are additionally swiveled with essentially same direction and speed as the moved storage cells.

7. The method according to claim 2, wherein items of mail are distributed among streams of items of mail in such a way that an average length of an item of mail in each stream of items of mail is approximately the same per defined time unit.

8. A device for pre-sorting loose and scanned flat items of mail, having distributing information, to a plurality of areas of sorting terminal stations of an item of mail sorting system, with a plurality of adjacent, narrow and laterally open storage cells which accommodate one item of mail at a time in an upright position on one narrow side, are fastened to a continuous traction means which circulates at constant speed, and whose narrow sides are aligned perpendicularly with respect to the direction of movement of the storage cells, and which, in a loading and unloading section of the circulation, can be loaded via the one open narrow side by means of one or more adjacent conveying devices and can be unloaded from the other open narrow side by means of a plurality of adjacent conveying devices, wherein, so that sorting outward transfer out of specific storage cells which are moved past can be carried out as a function of the known distributing information which is assigned to the items of mail and as a function of the active sorting scheme, the unloading conveying devices can be moved and actuated independently of one another over an area spanning a plurality of storage cell widths.

9. The device according to claim 8, wherein the loaded conveying devices further comprise means for moving and independently actuating over an area spanning a plurality of storage cell widths.

10. The device according to claim 8, wherein the continuous traction means extends in the form of a double helix.
